(19) United States
(12) Patent Application Publication
(10) Pub. No.: US 2007/0044850 A1
(43) Pub. Date: Mar. 1, 2007

(54) Fluid control apparatus for a faucet

(75) Inventor: Frank T. Pieters, Pointe-Claire (CA)

Correspondence Address: TROXELL LAW OFFICE PLLC, SUITE 1404, 5205 LEESBURG PIKE, FALLS CHURCH, VA, 22041, US

(73) Assignee: Globe Union Industrial Corp.

(21) Appl. No.: 11/215,028

(22) Filed: Aug. 31, 2005

(51) Int. Cl. F16K 11/074

(52) U.S. Cl. 137/597

(57) ABSTRACT

A fluid control apparatus includes a cartridge valve with a stationary valve disk and a sliding valve disk. The stationary valve disk has a first mixing water passage and a second mixing water passage. The sliding valve disk is slidably mounted on the stationary valve disk between a first and a second open position, and has a first and a second water mixing chamber. The first water mixing chamber mixes hot and cold water and is communicated with the first mixing water passage when the sliding valve disk is in the first open position. The second water mixing chamber mixes hot and cold water and is communicated with the second mixing water passage when the sliding valve disk is in the second open position. Consequently, the fluid control apparatus provides two outlets of mixing water to extend convenient usages of faucets.

### BACKGROUND OF THE INVENTION

1. Field of the Invention

The present invention relates to a fluid control apparatus for a faucet, and more particularly to fluid control apparatus has a cartridge valve, and the cartridge valve has two water outlets.

2. Description of Related Art

Valves are commonly used to control the flow of a fluid between an inlet and an outlet in a plumbing fixture. For example, a common faucet uses at least one valve inside to control the flow of water. The faucet discharges a stream of water when the valve is opened. Some kinds of faucets, such as bathtub taps, kitchen faucets and dual operation electronic faucets need mixing valves and diverter valves to mix hot and cold water and vary the flow of mixing water to different outlets.

A bathtub tap uses both the mixing valve and the diverter valve so that the hot and cold water is mixed to adjust its temperature, and the mixing water flows out of the tap through either a showerhead or a spout in the tap. However, using two separate valves causes the bathtub tap to have complex assemblies and fabrications. The manufacturing cost is expensive. In addition, to maintain the bathtub tap is not easy.

Germs, bacteria, disease and other harmful materials may be spread from one person to another person by touching the handles of the faucets in the public places. The electronic faucets have become popular in public places because a person will not touch the handles of the electronic faucets, which improves public sanitation. However, an electronic faucet needs power to drive the solenoid valve to open or close. If the power to the electronic faucet or the solenoidvalve fails, the electronic faucet will not function normally to discharge water. A person will be inconvenienced in using the electronic faucet in such a situation.

A dual operation electronic faucet that provides two selectable modes of automatic and manual operations addresses the aforesaid problem of the conventional electronic faucet. In the automatic operation mode, the electronic faucet uses sensors to detect objects approaching the faucet, and then a control circuit opens an solenoid valve to provide a stream of water discharging out the faucet. In the manual operation mode, a person pushes the handle of the electronic faucet, which permits the electronic faucet to supply water before the control circuit is fixed or the power is supplied again. Therefore, the dual operation electronic faucet needs two separate water passages for different operation modes. Since the dual operation electronic faucet has two separate water passages, the dual operation electronic faucet needs a valve with two outlets communicated respectively with the water passages to selectively divert the water into one of the water passages. The conventional valve with two outlets for the electronic faucet has a complex structure and is expensive. Therefore, an inexpensive cartridge valve with two outlets is still in demand.

To overcome the shortcomings, the present invention provides a fluid control apparatus that has a cartridge valve with two outlets to mitigate or obviate the aforementioned problems.

### SUMMARY OF THE INVENTION

An objective of the present invention is to provide a fluid control apparatus for a faucet, and the fluid control apparatus has two outlets to connect respectively two separate water conduits.

Another objective of the present invention is to provide a fluid control apparatus for mixing hot and cold water and varying the mixing water to separate water conduits.

A fluid control apparatus in accordance with the present invention includes a cartridge valve with a stationary valve disk and a sliding valve disk. The stationary valve disk has a first and a second mixing water passage. The sliding valve disk is mounted on the stationary valve disk between a first and a second open position, and has a first and a second water mixing chamber. The first water mixing chamber mixes hot and cold water and is communicated with the first mixing water passage when the sliding valve disk is in the first open position. The second water mixing chamber mixes hot and cold water and is communicated with the second mixing water passage. Consequently, the fluid control apparatus provides two outlets to discharge variable temperature mixed water to extend convenient usages of faucets.

Other objectives, advantages and unique features of the invention will become more apparent from the following detailed description when taken in conjunction with the accompanying drawings.

### BRIEF DESCRIPTION OF THE DRAWINGS

FIG. 1 is an exploded perspective view of a fluid control apparatus in accordance with the present invention;

FIG. 2 is a top view of a stationary valve disk of a cartridge valve of the fluid control apparatus in FIG. 1 when the cartridge valve is closed;

FIG. 3 is an operational top view of the stationary valve disk in FIG. 2 with a sliding valve disk of the cartridge valve being in a first open position;

FIG. 4 is an operational top view of valve disks in FIG. 3 when the sliding valve disk is rotated on the stationary valve disk to adjust water temperature;

FIG. 5 is an operational top view of the stationary valve disk in FIG. 2 with a sliding valve disk of the cartridge valve being in a second open position;

FIG. 6 is an operational top view of valve disks in FIG. 5 when the sliding valve disk is rotated on the stationary valve disk to adjust water temperature;

FIG. 7 is a schematic view of a second embodiment of a fluid control apparatus in accordance with the present invention when the fluid control apparatus is used in an electronic faucet;

FIG. 8 is an operational top view of a stationary and a sliding valve disk of the fluid control apparatus in FIG. 7 when the sliding valve disk is in a first open position; and

FIG. 9 is an operational top view of the stationary and the sliding valve disk of the fluid control apparatus in FIG. 8 when the sliding valve disk is in a second open position.

### DETAILED DESCRIPTION OF PREFERRED EMBODIMENT

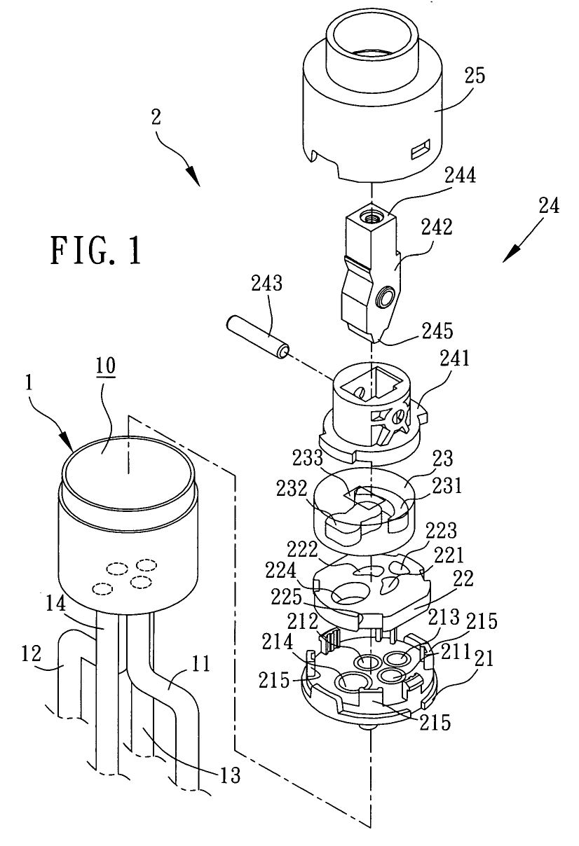

With reference to FIG. 1, a fluid control apparatus in accordance with the present invention comprises a valve seat 1, a cartridge vale 2 and multiple water conduits. The fluid control apparatus may be used in a faucet tap for mixing hot and clod water and diverting mixing water.

The valve seat 1 may be a hollow cylinder, has a top opening 10. The water conduits are connected to the valve seat 1 and include a hot water supply conduit 11, a cold water supply conduit 12, a first mixing water conduit 13 and a second mixing water conduit 14. The flows of the hot and the cold water flow through the hot and the cold water supply conduit 11,12 and enter the cartridge valve 2 in the valve seat 1.

The cartridge valve 2 mixes the hot and the cold water to adjust water temperature to a desired degree and redirects the mixing water out of the fluid control apparatus through either the first or the second mixing water conduit 13,14. The first and the second mixing water conduit 13,14 are connected respectively to a solenoid valve (not shown) and a spout (not shown) of a faucet.

The cartridge valve 2 is mounted in the valve seat 1 through the top opening 10, is held in the valve seat 1 and comprises a base 21, a stationary valve disk 22, a sliding valve disk 23, an actuating assembly 24 and a housing 25.

The base 21 has a top, two inlets 211,212, two outlets 213,214 and multiple positioning posts 215. The inlets include a hot water inlet 211 and a cold water inlet 212, are defined completely through the base 21 and communicate respectively with the hot and the cold water supply conduit 11, 12. The outlets include a first water outlet 213 and a second water outlet 214, are defined completely through the base 21 and communicate respectively with the first and the second mixing water conduit 13, 14. The positioning posts 215 are formed upwardly and radially on the top of the base 21.

The stationary valve disk 22 may be made of ceramic materials, is mounted on the top of the base 21 between the positioning posts 215 and has a hot water passage 221, a cold water passage 222, a first mixing water passage 223, a second mixing water passage 224 and multiple detents 225. Those passages 221,222,223,224 are defined completely through the stationary disk 22, are respectively arranged with the inlets 211,212 and the outlets 213,214 and communicate respectively with the corresponding inlets 211,212 and outlets 213,214 in the base 21. The detents 225 are formed and arranged corresponding to the positioning posts 215 in the base 21. Each detent 225 receives and holds a corresponding one of the positioning posts 215 so that the stationary valve disk 22 is held on the top of the base 21 in position.

The sliding valve disk 23 may be made of ceramic materials, is slidably mounted on the stationary valve disk 22 between a first and a second open position, and has a top and a bottom. The bottom of the sliding valve disk 23 is slidably mounted on the stationary valve disk 22 and has a first water mixing chamber 231 and a second water mixing chamber 232. The top of the sliding valve disk 23 has a recess 233.

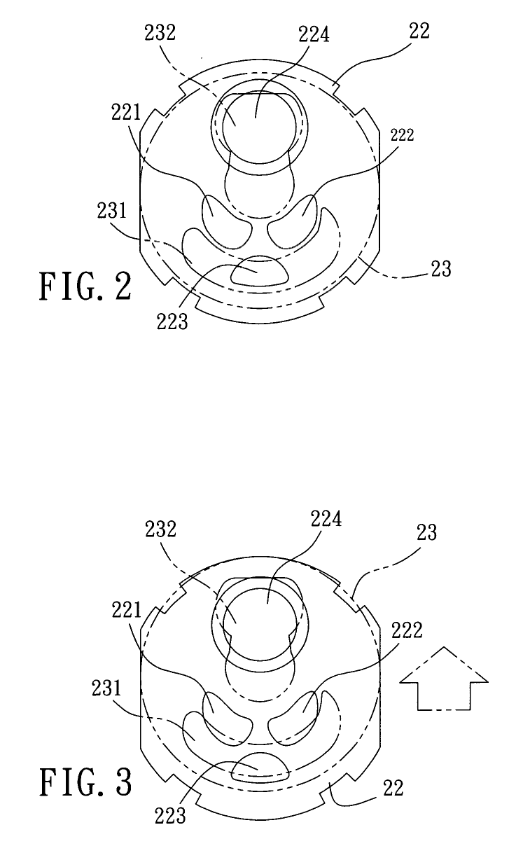

With further reference to FIGS. 2 and 3, the first and the second water mixing chamber 231,232 do not communicate with both the hot water passage 221 and cold water passage 222 in the stationary valve disk 22 when the cartridge valve 2 is closed. The first water mixing chamber 231 will be communicated simultaneously with the first mixing water passage 223, the hot water passage 221 and cold water passage 222 when the sliding valve disk 23 is moved relative to the stationary valve disk 22 in the first open position to open the cartridge valve 2. The separate water flows of hot and cold water are mixed in the first water mixing chamber 231, and then the mixing water enters the first mixing water conduit 13 through the first mixing water passage 223 and the first water outlet 213.

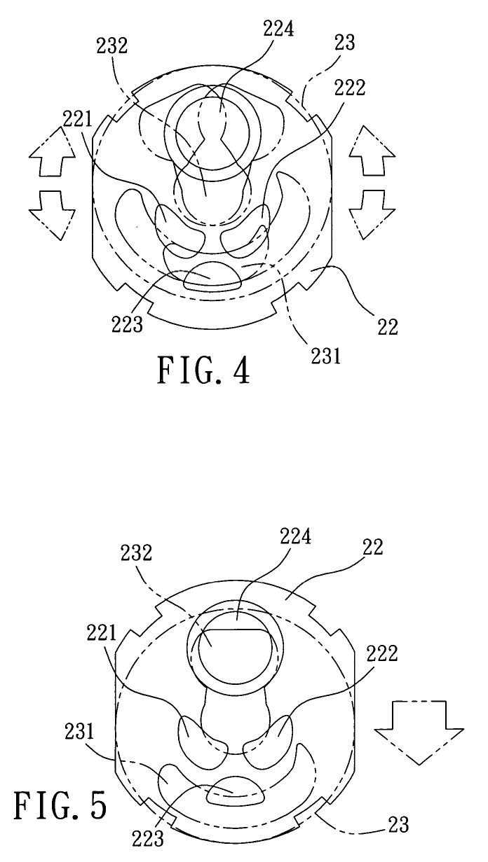

With further reference to FIG. 4, rotations of the sliding valve disk 23 will change the angular positions of the first water mixing chamber 231, which changes overlapping areas between the first water mixing chamber 231 and the hot and cold water passage 221,222. Therefore, the temperature of the mixing water in the first water mixing chamber 231 is adjustable as the sliding valve disk 13 is maintained in the first open position.

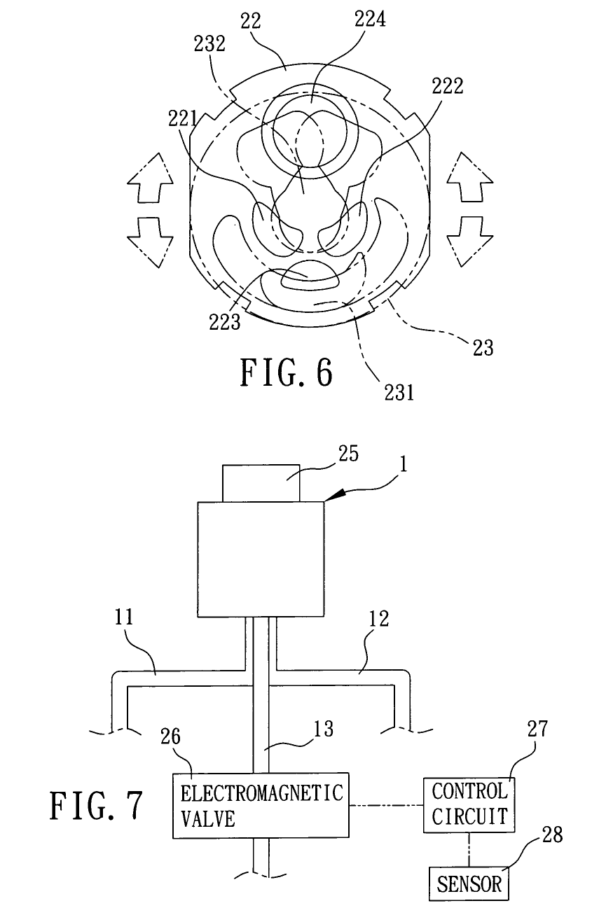

With reference to FIGS. 1, 5 and 6, the second water mixing chamber 232 will be communicated simultaneously with the second mixing water passage 224, the hot water passage 221 and cold water passage 222 when the sliding valve disk 23 is moved relative to the stationary valve disk 22 in the second open position to open the cartridge valve 2. The separate water flows of hot and cold water are mixed in the second water mixing chamber 232, and then the mixing water enters the second mixing water conduit 14 through the second mixing water passage 224 and the second water outlet 214. Likewise, rotations of the sliding valve disk 23 will change the angular positions of the second water mixing chamber 232, which changes overlapping areas between the second water mixing chamber 232 and the hot and cold water passage 221,222. Therefore, the temperature of the mixing water in the second water mixing chamber 232 is adjustable as the sliding valve disk 23 is maintained in the second open position.

The actuating assembly 24 is mounted in the housing 25 above the sliding valve disk 23 to move and rotate the sliding valve disk 23 and comprises an inner seat 241, a pivot rod 242 and a pivot pin 243. The inner seat 241 is rotatably mounted and held in the housing 25. The pivot rod 242 is pivotally mounted in the inner seat 241 by means of the pivot pin 243 and has a top end 244 and a bottom end 245. The ends 244,245 of the pivot rod 242 extend respectively out the inner seat 241. The extended top end 244 is connected to a handle (not shown). The extended bottom end 245 is extended into and is held in the recess 233 in the sliding valve disk 23. Therefore, pivoting the pivot rod 242 by the handle will move the sliding valve disk 23 relative to the stationary valve disk 22 to open the cartridge valve 2 when the sliding valve disk 23 is either in the first or the second open position. Rotating the inner seat 241 relative to the housing 25 will permit to adjust water temperature when the cartridge valve 2 is open.

The housing 25 holds the inner seat 241 and the valve disks 22, 23 and is attached to the base 21.

The cartridge valve 2 in accordance with the present invention has a dual function of mixing and varying hot and cold water and can be used as a mixing valve and a diverter valve.

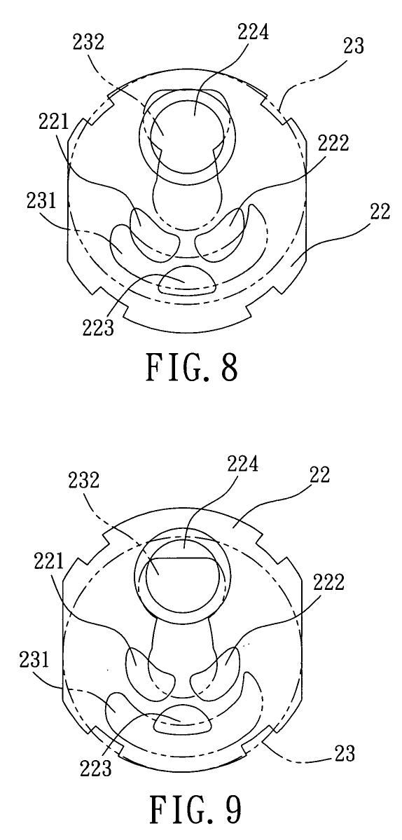

With reference to FIGS. 1, 7 and 8, an alternative embodiment of a fluid control apparatus in accordance with the present is mounted in a dual operation electronic faucet (not shown) and further comprises a normally closed solenoid valve 26, a control circuit 27 and a sensor 28. The cartridge valve 2 is mounted in the dual operation electronic faucet, the first mixing water conduit 13 is connected to a solenoid valve (not shown) of the electronic faucet and the second mixing water conduit 14 is directly connected to the spout. The control circuit 27 is coupled to the solenoid valve 26 to open and close the solenoid valve 26 so that the mixing water will flow out of the spout. The sensor 28 may use a touchless photo detector, such as a light emitting diode (LED) and is connected to the control circuit 27.

With further reference to FIG. 9, the sliding valve disk 23 is manually moved to the second open position when the power fails or the control circuit 27 or the solenoid valve 26 is damaged. The mixing water will bypass the solenoid valve 26 and be discharged out of the spout of the electronic faucet through the second mixing water conduit 14 so that the electronic faucet still can provide a steam of water by manual operation. The sliding valve disk 23 is pulled back to its original first open position by pivoting the pivot rod 242 to stop to discharge the steam of water through the spout.

Consequently, the cartridge valve 2 in accordance with the present invention has a dual function of mixing and varying water, which reduces an amount of components of a faucet. The manufacturing costs of the faucets will be lowered. Furthermore, the cartridge valve 2 allows an electronic faucet to provide two selectable operation modes including an automatic operation mode and a manual operation mode. Even if in a situation of that the power fails or the control circuit is damaged, the electronic faucet still can provide water by selecting the manual operation mode so that a person can conveniently use the electronic faucet any time.

Even though details of the structure and numerous advantages of the present invention have been set forth in the foregoing description, the disclosure is illustrative only. Persons skilled in the art will recognize that the invention can be practiced with modifications, within the spirit and scope of the appended claims.

What is claimed is:

1. A fluid control apparatus comprising:
a hollow valve seat having a hot water supply conduit, a cold water supply conduit, a first mixing water conduit and a second mixing water conduit;
a cartridge valve mounted in the hollow valve seat and comprising a base having a hot water inlet communicated with the hot water supply conduit, a cold water inlet communicated with the cold water supply conduit, a first water outlet communicated with the first mixing water conduit and a second water outlet communicated with the second mixing water conduit;
a housing mounted in the hollow valve seat and attached to the base; a stationary valve disk mounted on the base, held in the housing and having a hot water passage communicated with the hot water inlet, a cold water passage communicated with the cold water inlet, a first mixing water passage communicated with the first water outlet and a second mixing water passage communicated with the second water outlet;
a sliding valve disk slidably mounted on the stationary valve disk between a first and a second open position and having a first water mixing chamber and a second water mixing chamber; and
an actuating assembly mounted in the housing above the sliding valve disk and connected to the sliding valve disk to change positions of the sliding valve disk relative to the stationary valve disk;
wherein, the first water mixing chamber in the sliding valve disk will be communicated with the first mixing water passage and at least one of the hot and the cold water passage in the stationary valve disk when the sliding valve disk is in the first open position, and the second water mixing chamber in the sliding valve disk will be communicated with the second mixing water passage and at least one of the hot and the cold water passage in the stationary valve disk when the sliding valve disk is in the second open position.

2. The fluid control apparatus as claimed in claim 1, wherein the first water mixing chamber in the sliding valve disk communicates with the first mixing water passage and both the hot and the cold water passage in the stationary valve disk when the sliding valve disk is in the first open position.

3. The fluid control apparatus as claimed in claim 1, wherein the second water mixing chamber in the sliding valve disk communicates with the second mixing water passage and both the hot and the cold water passage in the stationary valve disk when the sliding valve disk is in the second open position.

4. The fluid control apparatus as claimed in claim 1, wherein the base further has a top and multiple positioning posts formed upwardly and radially on the top of the base; and
the stationary valve disk is mounted on the top of the base between the positioning posts and further has multiple detents corresponding respectively to the positioning posts;
wherein, each detent receives and holds a corresponding one of the positioning posts.

5. The fluid control apparatus as claimed in claim 1, wherein both the stationary valve disk and the sliding valve disk are made of ceramic materials.

6. The fluid control apparatus as claimed in claim 1, wherein the sliding valve disk further has a top, a bottom and a recess, and the recess is defined in the top, and the first and the second water mixing chamber are defined in the bottom; and
the actuating assembly comprises
an inner seat rotatably mounted and held in the housing; and
a pivot rod pivotally mounted in the inner seat and has a top end and a bottom end, wherein the ends of the pivot rod extend respectively out the inner seat, and the bottom end of the pivot rod is extended and held in the recess in the sliding valve disk.

7. The fluid control apparatus as claimed in claim 1, further comprising
a normally closed solenoid valve connected to the first mixing water conduit;
a control circuit coupled to the solenoid valve to control operations of the solenoid valve; and
a sensor connected to the control circuit.

8. The fluid control apparatus as claimed in claim 7, wherein the sensor is a touchless photo detector.

9. The fluid control apparatus as claimed in claim 7, wherein both the stationary and the sliding valve disk are made of ceramic materials.
